(19) United States
(12) Patent Application Publication
(10) Pub. No.: US 2014/0178606 A1
(43) Pub. Date: Jun. 26, 2014

(54) CELLULOSE ACYLATE FILM, POLARIZER, AND LIQUID CRYSTAL DISPLAY DEVICE

(71) Applicant: FUJIFILM Corporation, Tokyo (JP)

(72) Inventors: Takashi TAMADA, Kanagawa (JP); Akihiro MATSUFUJI, Kanagawa (JP); Jun TAKEDA, Kanagawa (JP)

(73) Assignee: FUJIFILM CORPORATION, Tokyo (JP)

(21) Appl. No.: 14/189,558

(22) Filed: Feb. 25, 2014

Related U.S. Application Data
(63) Continuation of application No. PCT/JP2012/072516, filed on Aug. 29, 2012.

(30) Foreign Application Priority Data
Aug. 31, 2011 (JP) 2011-188351

(51) Int. Cl. G02B 1/10

(52) U.S. Cl. CPC G02B 1/105
USPC 428/1.31; 536/63; 428/220; 106/168.01; 428/532

(57) ABSTRACT

A cellulose acylate film containing a cellulose acylate, that has an aromatic group-containing acyl group and satisfies the formulae (I) and (II):

0.9≦DSA≦2.0 (I)

0.9≦DS≦2.0 (II)

wherein DSA is a degree of substitution with the aromatic group-containing acyl group and DS is a total degree of substitution.

### CROSS-REFERENCE TO RELATED APPLICATIONS

This application is a continuation application of International Application No. PCT/JP2012/072516, filed Aug. 29, 2012, which in turn claims the benefit of priority from Japanese Application No. 2011-188351, filed Aug. 31, 2011, the disclosures of which Applications are incorporated by reference herein in their entirety.

### BACKGROUND OF THE INVENTION

1. Field of the Invention

The present invention relates to a cellulose acylate film useful as various parts of image display devices, etc., and to a polarizer and a liquid crystal display device using the film.

2. Background Art

Heretofore, a cellulose acylate film is used in liquid crystal display devices, as a protective film for polarizer therein or as a retardation film or the like. The mainstream of the cellulose acylate to be used as the starting material for the film is a triacetyl cellulose having acetyl groups; however, various proposals have been made for films containing a cellulose acylate that has an acyl group having an aromatic group. For example, Patent Reference 1 discloses a cellulose acylate film of a composition that contains a cellulose acylate of which the degree of acyl substitution falls within a predetermined range, saying that the film has a high Re and a low Rth.

A cellulose acylate film having an aromatic acyl group is also disclosed in Patent References 2 and 3. The cellulose acylate used for the films disclosed in these patent references is so specifically defined that the total degree of substitution with all the acyl groups including an aromatic acyl group therein is at least 2.3 or at least 2.5, and the patent references say that the reduction in the total degree of substitution is unfavorable from the viewpoint of the film formability of the cellulose acylate.
Patent Reference 1: JP-A 2009-235374
Patent Reference 2: JP-A 2006-328298
Patent Reference 3: JP-A 2008-163193

### SUMMARY OF THE INVENTION

The retardation film having a high Re and a low Rth disclosed in Patent Reference 1 is especially useful as an optical film for horizontal alignment mode liquid crystal display devices such as IPS-mode devices, etc.; and if one film could realize the intended characteristics, the film would be useful from the viewpoint of cost reduction and thinning of the devices. When combined with any other film, the film of the type is also useful as enlarging the latitude in optical planning of the film to be combined therewith. However, the cellulose acylate film having an acyl group containing an aromatic group is problematic in point of the handleability and the workability, and for example, the film is brittle and could hardly be stuck to any other parts such as polarizer or the like, and another problem of the film is that the adhesiveness thereof to such other parts is poor.

The present invention is to solve the above-mentioned problems. Concretely, objects of the invention are to provide a cellulose acylate film capable of realizing a high Re and a low Rth and is free from a problem of brittleness, and to provide a polarizer and a liquid crystal display device using the film.

With the increase in the degree of substitution with an aromatic acyl group in a cellulose acylate, the brittleness of the film comprising the cellulose acylate increases. On the other hand, for realizing a high Re and a low Rth, the degree of substitution with an aromatic acyl group must be increased in some degree; and heretofore, it has been difficult to satisfy both realization of high Re and low Rth and relief of brittleness. The present inventors have variously studied and, as a result, have found that the above-mentioned problems can be solved by lowering the total degree of acylation while keeping high the degree of substitution with an aromatic acyl group; and on the basis of this finding, the inventors have further made additional investigations and have completed the present invention. As described above, the conventional knowledge based on the premise of substitution with an aliphatic acyl group is that, for maintaining the film formability of the cellulose acylate, the total degree of acylation in the cellulose acylate is recognized to be high in some degree, or that is, the total degree thereof must be at least 2.3. In view of this, it is surprising and unexpected that both the realization of high Re and low Rth and the relief of brittleness can be satisfied by keeping high the degree of substitution with an aromatic acyl group and, for example, by lowering the degree of substitution with any other acyl group such as an acetyl group or the like, without detracting from the film formability of the cellulose acylate.

Specifically, the means for solving the above-mentioned problems are as follows:

[1]A cellulose acylate film composed of a composition that comprises at least one cellulose acylate, wherein the cellulose acylate has an aromatic group-containing acyl group, Substituent A, and satisfies the following formulae (I) and (II):

0.9≦DSA<2.0 (I)

0.9≦DS<2.0 (II)

wherein DSA is a degree of substitution with the Substituent A, and DS is a total degree of substitution.
[2] The cellulose acylate film of [1], satisfying 180 nm≦Re(550)≦300 nm, and 0 nm≦|Rth(550)|≦30 nm.
[3] The cellulose acylate film of [1] or [2], having a thickness of from 40 to 70 μm.
[4] The cellulose acylate film of any of [1] to [3], wherein the cellulose acylate further has an aliphatic acyl group, Substituent B.
[5] The cellulose acylate film of any of [1] to [4], wherein the Substituent B is an acetyl group.
[6] The cellulose acylate film of any of [1] to [5], wherein the degree of substitution with the Substituent B, DSB, satisfies the following formula (III):

0≦DSB<1.1 (III)

[7] The cellulose acylate film of any of [1] to [6], wherein the Substituent A is selected from a benzoyl group, a phenylbenzoyl group, a 4-heptylbenzoyl group, a 2,4,5-trimethoxybenzoyl group and a 3,4,5-trimethoxybenzoyl group.
[8] The cellulose acylate film of any of [1] to [7], comprising a plasticizer.
[9] The cellulose acylate film of any of [1] to [8], of which the PVA residual ratio in the cross-cut test of the laminate, as laminated with a polyvinyl alcohol film, is at least 85%.
[10]A polarizer having a polarizing film and the cellulose acylate film of any of [1] to [9].
[11] An image display device having the polarizer of [10].

According to the invention, there are provided a cellulose acylate film capable of realizing a high Re and a low Rth and free from a problem of brittleness, and a polarizer and a liquid crystal display device using the film.

### MODE FOR CARRYING OUT THE INVENTION

The invention is described in detail hereinunder.

In this description, the numerical range expressed by the wording “a number to another number” means the range that falls between the former number indicating the lower limit of the range and the latter number indicating the upper limit thereof.

### 1. Cellulose Acylate Film

The cellulose acylate film of the invention comprises a composition that contains at least one cellulose acylate, which has at least an aromatic group-containing acyl group (substituent A) and in which the degree of substitution with the substituent A, DSA satisfies the following formula (I) and the total degree of substitution DS satisfies the following formula (II):

0.9≦DSA<2.0 (I)

0.9≦DS<2.0 (II)

The cellulose acylate film of the invention realizes a high Re and a low Rth and is free from a problem of brittleness, and is therefore flexible when stuck to any other member such as a polarizer or the like. Accordingly, the adhesiveness of the film of the invention to any other member is good. The reason why the film of the invention has solved the problem of brittleness would be because the total degree of acylation of the film is lowered whereby the ratio of free OH in the cellulose could be thereby increased.

Preferably, the cellulose acylate film of the invention comprises the above-mentioned cellulose acylate as the main ingredient thereof, concretely in an amount of at least 50% by mass, more preferably at least 80% by mass, even more preferably at least 95% by mass. Needless-to-say, the content of the cellulose acylate in the film could be 100% by mass.

From the viewpoint of realizing high Re and low Rth, DSA is preferably at least 1.0, more preferably at least 1.2. On the other hand, when DSA is too high, the brittleness of the film would increase. From this viewpoint, DSA is preferably at most 1.9, more preferably at most 1.7, even more preferably at most 1.6.

From the viewpoint of relieving brittleness, DS is preferably at most 1.9. On the other hand, from the viewpoint of securing stable film formability, DS is preferably more than 0.9, more preferably at least 1.0, even more preferably at least 1.3.

Preferably, the cellulose acylate additionally has an aliphatic acyl group (substituent B) along with the substituent A therein. Preferably, DSA<DS. Having an aliphatic alkyl group, especially an aliphatic alkyl group having a low carbon number, the film can realize a suitable strength, not lowering Tg and the modulus of elasticity thereof. The degree of substitution with the substituent B, DSB is not specifically defined so far as it falls within a range within which DSA and DS satisfy the above-mentioned formulae (I) and (II). Preferably, DSB is from 0 to less than 1.1, more preferably from 0.1 to 1.0.

In the invention, the degree of substitution with a substituent can be determined through ¹H-NMR or ¹³C-NMR according to the method described in Cellulose Communication 6, 73-79 (1999) and Chirality 12(9), 670-674.

### (Aromatic Group-Containing Acyl Group (Substituent A))

The aromatic group-containing acyl group (substituent A) in the invention may directly bond to the ester bonding moiety or may bond thereto via a linking group. Preferred is direct bonding. The linking group as referred to herein means an alkylene group, an alkenylene group or an alkynylene group, and the linking group may have a substituent. The linking group is preferably an alkylene group, an alkenylene group or an alkynylene group having from 1 to 10 carbon atoms, more preferably an alkylene group or an alkenylene group having from to 6 carbon atoms, most preferably an alkylene group or an alkenylene group having from 1 to 4 carbon atoms.

The aromatic rings may have a substituent. Examples of the substituents on the aromatic rings or the above linking groups include an alkyl group (preferably having from 1 to 20 carbon atoms, more preferably from 1 to 12 carbon atoms, even more preferably from 1 to 8 carbon atoms, for example, a methyl group, an ethyl group, a propyl group, an isopropyl group, a tert-butyl group, an n-butyl group, an n-octyl group, an n-decyl group, an n-hexadecyl group, a cyclopropyl group, a cyclopentyl group, a cyclohexyl group, etc.), an alkenyl group (preferably having from 2 to 20 carbon atoms, more preferably from 2 to 12 carbon atoms, even more preferably from 2 to 8 carbon atoms, for example, a vinyl group, an allyl group, a 2-butenyl group, a 3-pentenyl group, etc.), an alkynyl group (preferably having from 2 to 20 carbon atoms, more preferably from 2 to 12 carbon atoms, even more preferably from 2 to 8 carbon atoms, for example, a propargyl group, a 3-pentynyl group, etc.), an aryl group (preferably having from 6 to 30 carbon atoms, more preferably from 6 to 20 carbon atoms, even more preferably from 6 to 12 carbon atoms, for example, a phenyl group, a biphenyl group, a naphthyl group, etc.), an amino group (preferably having from 0 to 20 carbon atoms, more preferably from 0 to 10 carbon atoms, even more preferably from 0 to 6 carbon atoms, for example, an amino group, a methylamino group, a dimethylamino group, a diethylamino group, a dibenzylamino group, etc.), an alkoxy group (preferably having from 1 to 20 carbon atoms, more preferably from 1 to 12 carbon atoms, even more preferably from 1 to 8 carbon atoms, for example, a methoxy group, an ethoxy group, a butoxy group, etc.), an aryloxy group (preferably having from 6 to 20 carbon atoms, more preferably from 6 to 16 carbon atoms, even more preferably from 6 to 12 carbon atoms, for example, a phenyloxy group, a 2-naphthyloxy group, etc.), an acyl group (preferably having from 1 to 20 carbon atoms, more preferably from 1 to 16 carbon atoms, even more preferably from 1 to 12 carbon atoms, for example, an acetyl group, a benzoyl group, a formyl group, a pivaloyl group, etc.), an alkoxycarbonyl group (preferably having from 2 to 20 carbon atoms, more preferably from 2 to 16 carbon atoms, even more preferably from 2 to 12 carbon atoms, for example, a methoxycarbonyl group, an ethoxycarbonyl group, etc.), an aryloxycarbonyl group (preferably having from 7 to 20 carbon atoms, more preferably from 7 to 16 carbon atoms, even more preferably from 7 to 10 carbon atoms, for example, a phenyloxycarbonyl group, etc.), an acyloxy group (preferably having from 2 to 20 carbon atoms, more preferably from 2 to 16 carbon atoms, even more preferably from 2 to 10 carbon atoms, for example, an acetoxy group, a benzoyloxy group, etc.), an acylamino group (preferably having from 2 to 20 carbon atoms, more preferably from 2 to 16 carbon atoms, even more preferably from 2 to 10 carbon atoms, for example, an acetylamino group, a benzoylamino group, etc.), an alkoxycarbonylamino group (preferably having from 2 to 20 carbon atoms, more preferably from 2 to 16 carbon atoms, even more preferably from 2 to 12 carbon atoms, for example, a methoxycarbonylamino group, etc.), an aryloxycarbonylamino group (preferably having from 7 to 20 carbon atoms, more preferably from 7 to 16 carbon atoms, even more preferably from 7 to 12 carbon atoms, for example, a phenyloxycarbonylamino group, etc.), a sulfonylamino group (preferably having from 1 to 20 carbon atoms, more preferably from 1 to 16 carbon atoms, even more preferably from 1 to 12 carbon atoms, for example, a methanesulfonylamino group, a benzenesulfonylamino group, etc.), a sulfamoyl group (preferably having from 0 to 20 carbon atoms, more preferably from 0 to 16 carbon atoms, even more preferably from 0 to 12 carbon atoms, for example, a sulfamoyl group, a methylsulfamoyl group, a dimethylsulfamoyl group, a phenylsulfamoyl group, etc.), a carbamoyl group (preferably having from 1 to 20 carbon atoms, more preferably from 1 to 16 carbon atoms, even more preferably from 1 to 12 carbon atoms, for example, a carbamoyl group, a methylcarbamoyl group, a diethylcarbamoyl group, a phenylcarbamoyl group, etc.), an alkylthio group (preferably having from 1 to 20 carbon atoms, more preferably 1 to 16 carbon atoms, even more preferably from 1 to 12 carbon atoms, for example a methylthio group, an ethylthio group, etc.), an arylthio group (preferably having from 6 to 20 carbon atoms, more preferably from 6 to 16 carbon atoms, even more preferably from 6 to 12 carbon atoms, for example, a phenylthio group, etc.), a sulfonyl group (preferably having from 1 to 20 carbon atoms, more preferably from 1 to 16 carbon atoms, even more preferably from 1 to 12 carbon atoms, for example, a mesyl group, a tolyl group, etc.), a sulfinyl group (preferably having from 1 to 20 carbon atoms, more preferably from 1 to 16 carbon atoms, even more preferably from 1 to 12 carbon atoms, for example, a methanesulfinyl group, a benzenesulfinyl group, etc.), an ureido group (preferably having from 1 to 20 carbon atoms, more preferably from 1 to 16 carbon atoms, even more preferably from 1 to 12 carbon atoms, for example, an ureido group, a methylureido group, a phenylureido group, etc.), a phosphoramido group (preferably having from 1 to 20 carbon atoms, more preferably from 1 to 16 carbon atoms, even more preferably from 1 to 12 carbon atoms, for example, a diethylphosphoramido group, a phenylphosphoramido group, etc.), a hydroxyl group, a mercapto group, a halogen atom (for example, fluorine atom, chlorine atom, bromine atom, iodine atom), a cyano group, a sulfo group, a carboxyl group, a nitro group, a hydroxamic acid group, a sulfino group, a hydrazino group, an imino group, a heterocyclic group (preferably having from 1 to 30 carbon atoms, more preferably from 1 to 12 carbon atoms, in which the hetero atom is, for example, a nitrogen atom, an oxygen atom or a sulfur atom, concretely including an imidazolyl group, a pyridyl group, a quinolyl group, a furyl group, a piperidyl group, a morpholino group, a benzoxazolyl group, a benzimidazolyl group, a benzothiazolyl group, etc.), a silyl group (preferably having from 3 to 40 carbon atoms, more preferably from 3 to 30 carbon atoms, even more preferably from 3 to 24 carbon atom, for example, a trimethylsilyl group, a triphenylsilyl group, etc.), etc. These substituents may be further substituted. In case where there exist two or more substituents, they may be the same or different, and if possible, they may bond to each other to form a ring.

Aromatic is defined as an aromatic compound in Dictionary of Physics and Chemistry (Iwanami Shoten), 4th Ed., p. 1208; and in the invention, the aromatic group may be an aromatic hydrocarbon group or an aromatic heterocyclic group, but is more preferably an aromatic hydrocarbon group.

Preferably, the aromatic hydrocarbon group has from 6 to carbon atoms, more preferably from 6 to 12 carbon atoms, most preferably from 6 to 10 carbon atoms. Specific examples of the aromatic hydrocarbon group include, for example, a phenyl group, a naphthyl group, an anthryl group, a biphenyl group, a terphenyl group, etc. More preferred is a phenyl group. Especially preferably, the aromatic hydrocarbon group is a phenyl group, a naphthyl group or a biphenyl group. The aromatic heterocyclic group is preferably one containing at least one of an oxygen atom, a nitrogen atom or a sulfur atom. Specific examples of the hetero ring include, for example, furan, pyrrole, thiophene, imidazole, pyrazole, pyridine, pyrazine, pyridazine, triazole, triazine, indole, indazole, purine, thiazoline, thiadiazole, oxazoline, oxazole, oxadiazole, quinoline, isoquinoline, phthalazine, naphthyridine, quinoxaline, quinazoline, cinnoline, puteridine, acridines, phenanthroline, phenazine, tetrazole, benzimidazole, benzoxazole, benzothiazole, benzotriazole, tetrazaindene, etc. The aromatic heterocyclic group is preferably a pyridyl group, a triazinyl group or a quinolyl group.

Preferred examples of the aromatic group-containing acyl group (substituent A) include a phenylacetyl group, a hydroxycinnamoyl group, a diphenylacetyl group, a phyenoxyacetyl group, a benzyloxyacetyl group, an O-acetylmanderyl group, a 3-methoxyphenylacetyl group, a 4-methoxyphenylacetyl group, a 2,5-dimethoxyphenylacetyl group, a 3,4-dimethoxyphenylacetyl group, a 9-fluorenylmethylacetyl group, a cinnamoyl group, a 4-methoxy-cinnamoyl group, a benzoyl group, an ortho-toluoyl group, a meta-toluoyl group, a para-toluoyl group, an m-anisolyl group, a p-anisolyl group, a phenylbenzoyl group, a 4-ethylbenzoyl group, a 4-propylbenzoyl group, a 4-t-butylbenzoyl group, a 4-butylbenzoyl group, a 4-pentylbenzoyl group, a 4-hexylbenzoyl group, a 4-heptylbenzoyl group, a 4-octylbenzoyl group, a 4-vinylbenzoyl group, a 4-ethoxybenzoyl group, a 4-butoxybenzoyl group, a 4-hexyloxybenzoyl group, a 4-heptyloxybenzoyl group, a 4-pentyloxybenzoyl group, a 4-octyloxybenzoyl group, a 4-nonyloxybenzoyl group, a 4-decyloxybenzoyl group, a 4-undecyloxybenzoyl group, a 4-dodecyloxybenzoyl group, a 4-isopropyloxybenzoyl group, a 2,3-dimethoxybenzoyl group, a 2,5-dimethoxybenzoyl group, a 3,4-dimethoxybenzoyl group, a 2,6-dimethoxybenzoyl group, a 2,4-dimethoxybenzoyl group, a 3,5-dimethoxybenzoyl group, a 3,4,5-trimethoxybenzoyl group, a 2,4,5-trimethoxybenzoyl group, a 1-naphthoyl group, a 2-naphthoyl group, a 2-biphenylcarbonyl group, a 4-biphenylcarbonyl group, a 4′-ethyl-4-biphenylcarbonyl group, a 4′-octyloxy-4-biphenylcarbonyl group, a piperonyloyl group, a diphenylacetyl group, a triphenylacetyl group, a phenylpropionyl group, a hydroxycinnamoyl group, an α-methylhydroxycinnamoyl group, a 2,2-diphenylpropionyl group, a 3,3-diphenylpropionyl group, a 3,3,3-triphenylpropionyl group, a 2-phenylbutyryl group, a 3-phenylbutyryl group, a 4-phenylbutyryl group, a 5-phenylvaleryl group, a 3-methyl-2-phenylvaleryl group, a 6-phenylhexanoyl group, an α-methoxyphenylacetyl group, a phenoxyacetyl group, a 3-phenoxypropionyl group, a 2-phenoxypropionyl group, a 11-phenoxydecanoyl group, a 2-phenoxybutyryl group, a 2-methoxyacetyl group, a 3-(2-methoxyphenyl)propionyl group, a 3-(p-toluyl)propionyl group, a (4-methylphenoxy)acetyl group, a 4-isobutyl-α-methylphenylacetyl group, a 4-(4-methoxyphenyl)butyryl group, a (2,4-di-t-pentylphenoxy)-acetyl group, a 4-(2,4-di-t-pentylphenoxy)butyryl group, a (3,4-dimethoxyphenyl)acetyl group, a 3,4-(methylenedioxy)phenylacetyl group, a 3-(3,4-dimethoxyphenyl)propionyl group, a 4-(3,4-dimethoxyphenyl)butyryl group, a (2,5-dimethoxyphenyl)acetyl group, a (3,5-dimethoxyphenyl)acetyl group, a 3,4,5-trimethoxyphenylacetyl group, a 3-(3,4,5-trimethoxyphenyl)propionyl group, an acetyl group, a 1-naphthylacetyl group, a 2-naphthylacetyl group, an α-trityl-2-naphthalene-propionyl group, a (1-naphthoxy) acetyl group, a (2-naphthoxy)acetyl group, a 6-methoxy-α-methyl-2-naphthaleneacetyl group, a 9-fluorenacetyl group, a 1-pyrenacetyl group, a 1-pyrenebutyryl group, a γ-oxo-pyrenebutyryl group, a styrenacetyl group, an α-methylcinnamoyl group, an α-phenylcinnamoyl group, a 2-methylcinnamoyl group, a 2-methoxcinnamoyl group, a 3-methoxycinnamoyl group, a 2,3-dimethoxycinnamoyl group, a 2,4-dimethoxycinnamoyl group, a 2,5-dimethoxycinnamoyl group, a 3,4-dimethoxycinnamoyl group, a 3,5-dimethoxycinnamoyl group, a 3,4-(methylenedioxy)cinnamoyl group, a 3,4,5-trimethoxycinnamoyl group, a 2,4,5-trimethoxycinnamoyl group, a 3-methylidene-2-carbonyl group, a 4-(2-cyclohexyloxy)benzoyl group, a 2,3-dimethylbenzoyl group, a 2,6-dimethylbenzoyl group, a 2,4-dimethylbenzoyl group, a 2,5-dimethylbenzoyl group, a 3-methoxy-4-methylbenzoyl group, a 3,4-diethoxybenzoyl group, an α-phenyl-o-toluyl group, a 2-phenoxybenzoyl group, a 2-benzoylbenzoyl group, a 3-benzoylbenzoyl group, a 4-benzoylbenzoyl group, a 2-ethoxy-1-naphthoyl group, a 9-fluorenecarbonyl group, a 1-fluorenecarbonyl group, a 4-fluorenecarbonyl group, a 9-anthracenecarbonyl group, a 1-pyrenecarbonyl group, etc.

Further preferred examples of the substituent A include a phenylacetyl group, a hydroxycinnamoyl group, a diphenylacetyl group, a phenoxyacetyl group, a benzyloxyacetyl group, an O-acetylmanderyl group, a 3-methoxyphenylacetyl group, a 4-methoxyphenylacetyl group, a 2,5-dimethoxyphenylacetyl group, a 3,4-dimethoxyphenylacetyl group, a 9-fluorenylmethylacetyl group, a cinnamoyl group, a 4-methoxy-cinnamoyl group, a benzoyl group, an ortho-toluoyl group, a meta-toluoyl group, a para-toluoyl group, an m-anisolyl group, a p-anisoyl group, a phenylbenzoyl group, a 4-ethylbenzoyl group, a 4-propylbenzoyl group, a 4-t-butylbenzoyl group, a 4-butylbenzoyl group, a 4-pentylbenzoyl group, a 4-hexylbenzoyl group, a 4-heptylbenzoyl group, a 4-octylbenzoyl group, a 4-vinylbenzoyl group, a 4-ethoxybenzoyl group, a 4-butyoxybenzoyl group, a 4-hexyloxybenzoyl group, a 4-heptyloxybenzoyl group, a 4-pentyloxybenzoyl group, a 4-octyloxybenzoyl group, a 4-nonyloxybenzoyl group, a 4-decyloxybenzoyl group, a 4-undecyloxybenzoyl group, a 4-dodecyloxybenzoyl group, a 4-isopropyloxybenzoyl group, a 2,3-dimethoxybenzoyl group, a 2,5-dimethoxybenzoyl group, a 3,4-dimethoxybenzoyl group, a 2,6-dimethoxybenzoyl group, a 2,4-dimethoxybenzoyl group, a 3,5-dimethoxybenzoyl group, a 2,4,5-trimethoxybenzoyl group, a 3,4,5-trimethoxybenzoyl group, a 1-naphthoyl group, a 2-naphthoyl group, a 2-biphenylcarbonyl group, a 4-biphenylcarbonyl group, a 4′-ethyl-4-biphenylcarbonyl group, and a 4′-octyloxy-4-biphenylcarbonyl group.

More preferably, the substituent A is a phenylacetyl group, a diphenylacetyl group, a phenoxyacetyl group, a cinnamoyl group, a 4-methoxycinnamoyl group, a benzoyl group, a phenylbenzoyl group, a 4-ethylbenzoyl group, a 4-propylbenzoyl group, a 4-t-butylbenzoyl group, a 4-butylbenzoyl group, a 4-pentylbenzoyl group, a 4-hexylbenzoyl group, a 4-heptylbenzoyl group, a 3,4-dimethoxybenzoyl group, a 2,6-dimethoxybenzoyl group, a 2,4-dimethoxoybenzoyl group, a 3,5-dimethoxybenzoyl group, a 3,4,5-trimethoxybenzoyl group, a 2,4,5-trimethoxybenzoyl group, a 1-naphthoyl group, a 2-naphthoyl group, a 2-biphenylcarbonyl group, or a 4-biphenylcarbonyl group.

Even more preferably, the substituent A is a benzoyl group, a phenylbenzoyl group, a 4-heptylbenzoyl group, a 2,4,5-trimethoxybenzoyl group, or a 3,4,5-trimethoxybenzoyl group.

The substituent A that the cellulose acylate has may be one or more.

### (Aliphatic Acyl Group (Substituent B))

The aliphatic acyl group (substituent B) in the invention may be a linear, branched or cyclic aliphatic acyl group, or may contain an unsaturated bond. Preferably, the aliphatic acyl group has from 2 to 20 carbon atoms, more preferably from 2 to 10 carbon atoms, even more preferably from 2 to 4 carbon atoms. Preferred examples of the substituent B include an acetyl group, a propionyl group, and a butyryl group. Above all, especially preferred is an acetyl group.

In the invention, a cellulose acylate not containing an aliphatic acyl group like a case where DSA=DS is also usable.

The cellulose acylate is a compound having a cellulose skeleton, which is obtained biologically or chemically from a starting material cellulose by introducing at least an aromatic group-containing acyl group (substituent A) into the starting cellulose.

The starting cellulose for the cellulose acylate includes not only natural cellulose such as cotton linter, wood pulp (hardwood pulp, softwood pulp), etc., but also any other cellulose having a low degree of polymerization (degree of polymerization: 100 to 300) to be obtained through acidic hydrolysis of wood pulp, such as microcrystalline cellulose, etc. As the case may be, a mixture of those celluloses may be used here. The starting cellulose materials are described in detail, for example, in “Plastic Material Lecture (17), Cellulosic Resin” (written by Marusawa and Uda, published by Nikkan Kogyo Shinbun, 1970); Hatsumei Kyokai Disclosure Bulletin No. 2001-1745, pp. 7-8; and “Dictionary of Cellulose (p. 523)” (edited by the Society of Cellulose, published by Asakura Shoten, 2000). Cellulose materials described in these may be used here with no specific limitation.

The cellulose acylate for use in the invention may be obtained, for example, through reaction of a starting material of Aldrich's cellulose acylate (degree of acetyl substitution, 2.45) or Daicel's cellulose acetate (degree of acetyl substitution, 2.41 (trade name: L-70); degree of acetyl substitution, 2.19 (trade name: FL-70)); degree of acetyl substitution, 1.76 (trade name: LL-10) with the corresponding acid chloride.

Not specifically defined, the viscosity-average degree of polymerization of the cellulose acylate is preferably from 80 to 700, more preferably from 90 to 500, even more preferably from 100 to 500. When the mean degree of polymerization is at most 500, then the viscosity of the dope solution with the cellulose acylate is not too high, therefore tending to facilitate film formation by casting. When the mean degree of polymerization is at least 140, the formed film can favorably have an increased strength. The mean degree of polymerization can be measured according to an Uda et al's limiting viscosity method (written by Kazuo Uda and Hideo Saito, “the Journal of Society of Fiber and Technology Japan”, Vol. 18, No. 1, pp. 105-120, 1962). Concretely, the mean degree of polymerization may be measured according to the method described in JP-A 9-95538.

The cellulose acylate film of the invention comprises a composition containing at least one type of the above-mentioned cellulose acylate. Preferably, the cellulose acylate composition contains the above-mentioned cellulose acylate in an amount of from 70% by mass to 100% by mass of the total composition, more preferably from 80% by mass to 100% by mass, even more preferably from 90% by mass to 100% by mass.

The cellulose acylate composition may be in any form, for example, having a granular, powdery, fibrous, massive, solution, melt or the like form.

In film formation, a granular or powdery starting material is preferred, and therefore, the cellulose acylate composition after dried may be ground or sifted for uniformizing the particle size of the material or for enhancing the handleability thereof.

In the invention, one alone or two or more different types of cellulose acylates may be used. As the case may be, any other polymer component than cellulose acylate and various additives may be suitably mixed with the cellulose acylate. Preferably, the component to be mixed has good miscibility with cellulose acylate, and is mixed so that the film formed of the mixture could have a transmittance of at least 80%, more preferably at least 90%, even more preferably at least 92%.

In the invention, various additives that may be generally added to cellulose acylate (for example, UV inhibitor, plasticizer, antiaging agent, fine particles, optical characteristics-regulating agent, etc.) may be added to the cellulose acylate. Regarding the time when the additives are added to the cellulose acylate, the additives may be added thereto in any stage during dope preparation, or may be added thereto in the final step of dope preparation.

The cellulose acylate in the invention realizes a high Re even though an additive such as an Re enhancer or the like is not added thereto, and realizes a low Rth even through an Rth reducer is not added thereto. Needless-to-say, however, an additive contributing toward Re enhancement or Rth reduction may be added to the cellulose acylate. Examples of the additive that may be added the cellulose acylate in the invention include a high-molecular-weight additive. The high-molecular-weight additive has a recurring unit in the compound thereof. In general, the additive may be a compound grouped in oligomers. The high-molecular-weight additive is used for accelerating the evaporation speed of a solvent or for reducing the residual solvent amount in a solution casting method. Also in film formation according to a melt casting method, the high-molecular-weight additive is useful for preventing discoloration or film strength reduction. Further, adding the high-molecular-weight additive to the film of the invention is effective from the viewpoint of film property modification for improving the mechanical characteristics of film, for imparting flexibility to film, for imparting water absorption resistance thereto and for reducing the moisture permeability of film.

Further, the high-molecular-weight additive may also serve as an Rth reducer in the invention.

The high-molecular-weight additive for use in the invention is described in detail hereinunder with reference to its specific examples; needless-to-say, however, the high-molecular-weight additive for use in the invention is not limited to these examples.

The high-molecular-weight additive is selected from polyester polymers, styrenic polymers and acrylic polymers, and their copolymers. Preferred are aliphatic polyesters, aromatic polyesters, acrylic polymers and styrenic polymers.

### Polyester Polymer

The number-average molecular weight of the polyester polymer is more preferably from 700 to less than 10000, even more preferably from 800 to 8000, still more preferably from 800 to 5000, and especially preferably, the number-average molecular weight thereof is from 1000 to 5000. Having the molecular weight falling within the range, the additive is more excellent in miscibility with cellulose acylate. In particular, the content of the high-molecular-weight additive in the invention is preferably from 4 to 30% by mass of cellulose resin, more preferably from 10 to 25% by mass.

The polyester polymer is one to be obtained through reaction of a mixture of an aliphatic dicarboxylic acid having from 2 to 20 carbon atoms and an aromatic dicarboxylic acid having from 8 to 20 carbon atoms, and at least one diol selected from an aliphatic diol having from 2 to 12 carbon atoms, an alkyl ether diol having from 4 to 20 carbon atoms and an aromatic diol having from 6 to 20 carbon atoms, and both ends of the reaction product could be as they are in the reaction product, but may be capped through further reaction with a monocarboxylic acid, a monoalcohol or phenol. Effectively, the end capping is attained especially in order that the polymer does not contain any free carboxylic acid from the viewpoint of the storability thereof. The dicarboxylic acid to be used for the polyester polymer in the invention is preferably for an aliphatic dicarboxylic acid residue having from 4 to 20 carbon atoms or an aromatic dicarboxylic acid residue having from 8 to 20 carbon atoms.

The aliphatic dicarboxylic acid having from 2 to 20 carbon atoms preferably used in the invention includes, for example, oxalic acid, malonic acid, succinic acid, maleic acid, fumaric acid, glutaric acid, adipic acid, pimelic acid, suberic acid, azelaic acid, sebacic acid, dodecanedicarboxylic acid and 1,4-cyclohexanedicarboxylic acid. The aromatic dicarboxylic acid having from 8 to 20 carbon atoms includes phthalic acid, terephthalic acid, isophthalic acid, 1,5-naphthalenedicarboxylic acid, 1,4-naphthalenedicarboxylic acid, 1,8-naphthalenedicarboxylic acid, 2,8-naphthalenedicarboxylic acid, 2,6-naphthalenedicarboxylic acid, etc.

Of those, preferred aliphatic dicarboxylic acids are malonic acid, succinic acid, maleic acid, fumaric acid, glutaric acid, adipic acid, azelaic acid, 1,4-cyclohexanedicarboxylic acid; and preferred aromatic dicarboxylic acids are phthalic acid, terephthalic acid, isophthalic acid, 1,5-naphthalenedicarboxylic acid, 1,4-naphthalenedicarboxylic acid. More preferred aliphatic dicarboxylic acids are succinic acid, glutaric acid and adipic acid; and more preferred aromatic dicarboxylic acids are phthalic acid, terephthalic acid and isophthalic acid.

In the invention, of those mentioned above, at least one aliphatic dicarboxylic acid and at least one aromatic dicarboxylic acid are combined, and the combination thereof is not specifically defined. If desired, different types of the individual components may be combined in any desired manner with no problem.

The diol or the aromatic ring-containing diol to be used for the high-molecular-weight additive is selected from, for example, aliphatic diols having from 2 to 20 carbon atoms, alkyl ether diols having from 4 to 20 carbon atoms, and aromatic ring-containing diols having from 6 to 20 carbon atoms.

The aliphatic diol having from 2 to 20 carbon atoms includes alkyldiols and alicyclic diols. For example, there are mentioned ethanediol, 1,2-propanediol, 1,3-propanediol, 1,2-butanediol, 1,3-butanediol, 2-methyl-1,3-propanediol, 1,4-butanediol, 1,5-pentanediol, 2,2-dimethyl-1,3-propanediol (neopentyl glycol), 2,2-diethyl-1,3-propanediol (3,3-dimethylolpentane), 2-n-butyl-2-ethyl-1,3-propanediol (3,3-dimethylolheptane), 3-methyl-1,5-pentanediol, 1,6-hexanediol, 2,2,4-trimethyl-1,3-pentanediol, 2-ethyl-1,3-hexanediol, 2-methyl-1,8-octanediol, 1,9-nonanediol, 1,10-decanediol, 1,12-octadecanediol, etc. One alone or two or more different types of these glycols may be used here either singly or as combined as a mixture thereof.

Preferred aliphatic diols for the invention are ethanediol, 1,2-propanediol, 1,3-propanediol, 1,2-butanediol, 1,3-butanediol, 2-methyl-1,3-propanediol, 1,4-butanediol, 1,5-pentanediol, 3-methyl-1,5-pentanediol, 1,6-hexanediol, 1,4-cyclohexanediol, 1,4-cyclohexanedimethanol; and more preferred are ethanediol, 1,2-propanediol, 1,3-propanediol, 1,2-butanediol, 1,3-butanediol, 1,4-butanediol, 1,5-pentanediol, 1,6-hexanediol, 1,4-cyclohexanediol, 1,4-cyclohexanedimethanol.

The alkyl ether diol having from 4 to 20 carbon atoms is preferably polytetramethylene ether glycol, polyethylene ether glycol, polypropylene ether glycol and their combination.

Not specifically defined, the mean degree of polymerization of the diol is preferably from 2 to 20, more preferably from 2 to 10, even more preferably from 2 to 5, still more preferably from 2 to 4. As examples of the diol, there are mentioned typically useful, commercially-available polyether glycols, Carbowax Resin, Pluronics Resin and Niax Resin.

Not specifically defined, the aromatic diol having from to 20 carbon atoms include bisphenol A, 1,2-hydroxybenzene, 1,3-hydroxybenzene, 1,4-hydroxybenzene, 1,4-benzenedimethanol. Preferred are bisphenol A, 1,4-hydroxybenzene and 1,4-benzenedimethanol.

Preferably, the high-molecular-weight additive for use in the invention is one endcapped with an alkyl group or an aromatic group. This is because endcapping with a hydrophobic functional group is effective for enhancing the aging resistance of the compound in high-temperature high-humidity environments, and the endcapping group could act to retard the hydrolysis of the ester group.

Preferably, both ends of the polyester additive for use in the invention are protected with a monoalcohol residue or a monocarboxylic acid residue so as not to be a carboxylic acid group or an OH group.

In this case, the monoalcohol is preferably a substituted or unsubstituted monoalcohol having from 1 to 30 carbon atoms, including aliphatic alcohols such as methanol, ethanol, propanol, isopropanol, butanol, isobutanol, pentanol, isopentanol, hexanol, isohexanol, cyclohexyl alcohol, octanol, isooctanol, 2-ethylhexyl alcohol, nonyl alcohol, isononyl alcohol, tert-nonyl alcohol, decanol, dodecanol, dodecahexanol, dodecaoctanol, allyl alcohol, oleyl alcohol, etc.; and substituted alcohols such as benzyl alcohol, 3-phenylpropanol, etc.

Endcapping alcohols preferred for use in the invention are methanol, ethanol, propanol, isopropanol, butanol, isobutanol, isopentanol, hexanol, isohexanol, cyclohexyl alcohol, isooctanol, 2-ethylhexyl alcohol, isononyl alcohol, oleyl alcohol, benzyl alcohol; and more preferred are methanol, ethanol, propanol, isobutanol, cyclohexyl alcohol, 2-ethylhexyl alcohol, isononyl alcohol, benzyl alcohol.

In case where the additive is endcapped with a monocarboxylic acid residue, the monocarboxylic acid for the monocarboxylic acid residue is preferably a substituted or unsubstituted monocarboxylic acid having from 1 to 30 carbon atoms. The monocarboxylic acid may be an aliphatic monocarboxylic acid or an aromatic ring-containing monocarboxylic acid. As preferred aliphatic monocarboxylic acids for use herein, there are mentioned acetic acid, propionic acid, butanoic acid, caprylic acid, caproic acid, decanoic acid, dodecanoic acid, stearic acid, oleic acid; and preferred aromatic ring-containing monocarboxylic acids are, for example, benzoic acid, p-tert-butylbenzoic acid, p-tert-amylbenzoic acid, orthotoluic acid, metatoluic acid, paratoluic acid, dimethylbenzoic acid, ethylbenzoic acid, normal-propylbenzoic acid, aminobenzoic acid, acetoxybenzoic acid, etc. One or more of these may be used here.

The high-molecular-weight additive as mentioned above for the invention can be produced according to an ordinary method. For example, the additive can be produced with ease according to a thermal melt condensation method of polyesterification or interesterification of the above-mentioned dicarboxylic acid and diol and/or the endcapping monocarboxylic acid or monoalcohol; or according to an interfacial condensation method of an acid chloride of those acids and a glycol. The polyester additives are described in detail by Koichi Murai in “Additives, Theory and Application” (published by Miyuki Shobo Publishing, Mar. 1, 1973, 1st Printing of 1st Version). In addition, the materials described in JP-A 05-155809, JP-A 05-155810, JP-A 5-197073, JP-A 2006-259494, JP-A 07-330670, JP-A 2006-342227, and JP-A 2007-003679 are also usable here.

Specific examples of the polyester polymer usable in the invention are shown below. However, the polyester polymer for use in the invention is not limited to these.

TABLE 1

| | Dicarboxylic acid | | | Diol | | | Number- |
|---|---|---|---|---|---|---|---|
| | Aromatic | Aliphatic | Dicarboxylic | | Diol | | Average |
| | Dicarboxylic | Dicarboxylic | Acid Ratio | Aliphatic | Ratio | | Molecular |
| | Acid | Acid | (mol %) | Diol | (mol %) | End Group | Weight |
| P-1 | — | AA | 100 | ethanediol | 100 | hydroxyl group | 1000 |
| P-2 | — | AA | 100 | ethanediol | 100 | hydroxyl group | 2000 |
| P-3 | — | AA | 100 | propanediol | 100 | hydroxyl group | 2000 |
| P-4 | — | AA | 100 | butanediol | 100 | hydroxyl group | 2000 |
| P-5 | — | AA | 100 | hexanediol | 100 | hydroxyl group | 2000 |
| P-6 | — | AA/SA | 60/40 | ethanediol | 100 | hydroxyl group | 900 |
| P-7 | — | AA/SA | 60/40 | ethanediol | 100 | hydroxyl group | 1500 |
| P-8 | — | AA/SA | 60/40 | ethanediol | 100 | hydroxyl group | 1800 |
| P-9 | — | SA | 100 | ethanediol | 100 | hydroxyl group | 1500 |
| P-10 | — | SA | 100 | ethanediol | 100 | hydroxyl group | 2300 |
| P-11 | — | SA | 100 | ethanediol | 100 | hydroxyl group | 6000 |
| P-12 | — | SA | 100 | ethanediol | 100 | hydroxyl group | 1000 |
| P-13 | PA | SA | 50/50 | ethanediol | 100 | hydroxyl group | 1000 |
| P-14 | PA | SA | 50/50 | ethanediol | 100 | hydroxyl group | 1800 |
| P-15 | PA | AA | 50/50 | ethanediol | 100 | hydroxyl group | 2300 |
| P-16 | PA | SA/AA | 40/30/30 | ethanediol | 100 | hydroxyl group | 1000 |
| P-17 | PA | SA/AA | 50/20/30 | ethanediol | 100 | hydroxyl group | 1500 |
| P-18 | PA | SA/AA | 50/30/20 | ethanediol | 100 | hydroxyl group | 2600 |
| P-19 | TPA | SA | 50/50 | ethanediol | 100 | hydroxyl group | 1000 |
| P-20 | TPA | SA | 50/50 | ethanediol | 100 | hydroxyl group | 1200 |
| P-21 | TPA | AA | 50/50 | ethanediol | 100 | hydroxyl group | 2100 |
| P-22 | TPA | SA/AA | 40/30/30 | ethanediol | 100 | hydroxyl group | 1000 |
| P-23 | TPA | SA/AA | 50/20/30 | ethanediol | 100 | hydroxyl group | 1500 |
| P-24 | TPA | SA/AA | 50/30/20 | ethanediol | 100 | hydroxyl group | 2100 |
| P-25 | PA/TPA | AA | 15/35/50 | ethanediol | 100 | hydroxyl group | 1000 |
| P-26 | PA/TPA | AA | 20/30/50 | ethanediol | 100 | hydroxyl group | 1000 |
| P-27 | PA/TPA | SA/AA | 15/35/20/30 | ethanediol | 100 | hydroxyl group | 1000 |
| P-28 | PA/TPA | SA/AA | 20/30/20/30 | ethanediol | 100 | hydroxyl group | 1000 |
| P-29 | PA/TPA | SA/AA | 10/50/30/10 | ethanediol | 100 | hydroxyl group | 1000 |
| P-30 | PA/TPA | SA/AA | 5/45/30/20 | ethanediol | 100 | hydroxyl group | 1000 |
| P-31 | — | AA | 100 | ethanediol | 100 | acetyl ester residue | 1000 |
| P-32 | — | AA | 100 | ethanediol | 100 | acetyl ester residue | 2000 |
| P-33 | — | AA | 100 | propanediol | 100 | acetyl ester residue | 2000 |
| P-34 | — | AA | 100 | butanediol | 100 | acetyl ester residue | 2000 |
| P-35 | — | AA | 100 | hexanediol | 100 | acetyl ester residue | 2000 |
| P-36 | — | AA/SA | 60/40 | ethanediol | 100 | acetyl ester residue | 900 |

TABLE 2

| | Dicarboxylic Acid | | | Diol | | | Number- |
|---|---|---|---|---|---|---|---|
| | Aromatic | Aliphatic | Dicarboxylic | | Diol | | Average |
| | Dicarboxylic | Dicarboxylic | Acid Ratio | Aliphatic | Ratio | | Molecular |
| | Acid | Add | (mol %) | Diol | (mol %) | End Group | Weight |
| P-37 | — | AA/SA | 60/40 | ethanediol | 100 | acetyl ester residue | 1000 |
| P-38 | — | AA/SA | 60/40 | ethanediol | 100 | acetyl ester residue | 2000 |
| P-39 | — | SA | 100 | ethanediol | 100 | acetyl ester residue | 1000 |
| P-40 | — | SA | 100 | ethanediol | 100 | acetyl ester residue | 3000 |
| P-41 | — | SA | 100 | ethanediol | 100 | acetyl ester residue | 5500 |
| P-42 | — | SA | 100 | ethanediol | 100 | acetyl ester residue | 1000 |
| P-43 | PA | SA | 50/50 | ethanediol | 100 | acetyl ester residue | 1000 |
| P-44 | PA | SA | 50/50 | ethanediol | 100 | acetyl ester residue | 1500 |
| P-45 | PA | AA | 50/50 | ethanediol | 100 | acetyl ester residue | 1000 |
| P-46 | PA | SA/AA | 40/30/30 | ethanediol | 100 | acetyl ester residue | 1000 |
| P-47 | PA | SA/AA | 33/33/34 | ethanediol | 100 | benzoic acid residue | 1000 |
| P-48 | PA | SA/AA | 50/20/30 | ethanediol | 100 | acetyl ester residue | 1500 |
| P-49 | PA | SA/AA | 50/30/20 | ethanediol | 100 | acetyl ester residue | 2000 |
| P-50 | TPA | SA | 50/50 | ethanediol | 100 | acetyl ester residue | 1000 |
| P-51 | TPA | SA | 50/50 | ethanediol | 100 | acetyl ester residue | 1500 |
| P-52 | TPA | SA | 45/55 | ethanediol | 100 | acetyl ester residue | 1000 |
| P-53 | TPA | AA | 50/50 | ethanediol | 100 | acetyl ester residue | 2200 |
| P-54 | TPA | SA | 35/65 | ethanediol | 100 | acetyl ester residue | 1000 |
| P-55 | TPA | SA/AA | 40/30/30 | ethanediol | 100 | acetyl ester residue | 1000 |
| P-56 | TPA | SA/AA | 50/20/30 | ethanediol | 100 | acetyl ester residue | 1500 |
| P-57 | TPA | SA/AA | 50/30/20 | ethanediol | 100 | acetyl ester residue | 2000 |
| P-58 | TPA | SA/AA | 20/20/60 | ethanediol | 100 | acetyl ester residue | 1000 |
| P-59 | PA/TPA | AA | 15/35/50 | ethanediol | 100 | acetyl ester residue | 1000 |
| P-60 | PA/TPA | AA | 25/25/50 | ethanediol | 100 | acetyl ester residue | 1000 |
| P-61 | PA/TPA | SA/AA | 15/35/20/30 | ethanediol | 100 | acetyl ester residue | 1000 |
| P-62 | PA/TPA | SA/AA | 20/30/20/30 | ethanediol | 100 | acetyl ester residue | 1000 |
| P-63 | PA/TPA | SA/AA | 10/50/30/10 | ethanediol | 100 | acetyl ester residue | 1000 |
| P-64 | PA/TPA | SA/AA | 5/45/30/20 | ethanediol | 100 | acetyl ester residue | 1000 |
| P-65 | PA/TPA | SA/AA | 5/45/20/30 | ethanediol | 100 | acetyl ester residue | 1000 |
| P-66 | IPA | AA/SA | 20/40/40 | ethanediol | 100 | acetyl ester residue | 1000 |
| P-67 | 2,6-NPA | AA/SA | 20/40/40 | ethanediol | 100 | acetyl ester residue | 1200 |
| P-68 | 1,5-NPA | AA/SA | 20/40/40 | ethanediol | 100 | acetyl ester residue | 1200 |
| P-69 | 1,4-NPA | AA/SA | 20/40/40 | ethanediol | 100 | acetyl ester residue | 1200 |
| P-70 | 1,8-NPA | AA/SA | 20/40/40 | ethanediol | 100 | acetyl ester residue | 1200 |
| P-71 | 2,8-NPA | AA/SA | 20/40/40 | ethanediol | 100 | acetyl ester residue | 1200 |

In Table 1 and Table 2, PA is phthalic acid, TPA is terephthalic acid, IPA is isophthalic acid, AA is adipic acid, SA is succinic acid, 2,6-NPA is 2,6-naphthalenedicarboxylic acid, 2,8-NPA is 2,8-naphthalenedicarboxylic acid, 1,5-NPA is 1,5-naphthalenedicarboxylic acid, 1,4-NPA is 1,4-naphthalenedicarboxylic acid, 1,8-NPA is 1,8-naphthalenedicarboxylic acid.

### Styrenic Polymer

The styrenic polymer preferably has a structural unit derived from an aromatic vinylic monomer, as represented by the following general formula (1). The number-average molecular weight of the styrenic polymer for use in the invention is preferably from 700 to less than 100000, more preferably from 800 to 50000, even more preferably from 800 to 30000, especially preferably from 1000 to 20000. In the invention, the content of the high-molecular-weight additive is preferably from 4 to 30% by mass of the cellulose resin, more preferably from 10 to 25% by mass.

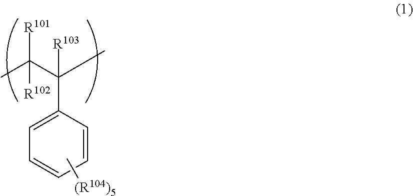

In the formula, R¹⁰¹ to R¹⁰⁴ each independently represent a hydrogen atom, a halogen atom, or a substituted or unsubstituted hydrocarbon atoms having from 1 to 30 carbon atoms and optionally having a linking group containing an oxygen atom, a sulfur atom, a nitrogen atom or a nitrogen atom, or represents a polar group; R¹⁰⁴'s all may be the same atoms or groups, or each may be a different atom or group, or they may bond to each other to form a carbon ring or a hetero ring (and the carbon ring and the hetero ring may be a monocyclic structure or may form a polycyclic structure as condensed with any other ring).

Specific examples of the aromatic vinylic monomer include styrene; alkyl-substituted styrenes such as α-methylstyrene, β-methylstyrene, p-methylstyrene, etc.; halogen-substituted styrenes such as 4-chlorostyrene, 4-bromostyrene, etc.; hydroxystyrenes such as p-hydroxystyrene, α-methyl-p-hydroxystyrene, 2-methyl-4-hydroxystyrene, 3,4-dihydroxystyrene, etc.; vinylbenzyl alcohols; alkoxy-substituted styrenes such as p-methoxystyrene, p-tert-butoxystyrene, m-tert-butoxystyrene, etc.; vinylbenzoic acids such as 3-vinylbenzoic acid, 4-vinylbenzoic acid, etc.; vinyl benzoates such as methyl 4-vinylbenzoate, ethyl 4-vinylbenzoate, etc.; 4-vinylbenzyl acetate; 4-acetoxystyrene; amidestyrenes such as 2-butylamidestyrene, 4-methylamidestyrene, p-sulfonamidestyrene, etc.; aminostyrenes such as 3-aminostyrene, 4-aminostyrene, 2-isopropenylaniline, vinylbenzyldimethylamine, etc.; nitrostyrenes such as 3-nitrostyrene, 4-nitrostyrene, etc.; cyanostyrenes such as 3-cyanostyrene, 4-cyanostyrene, etc.; vinylphenylacetonitrile; arylstyrenes such as phenylstyrene, etc.; indenes, etc. However, the invention is not limited to these specific examples. Two or more different types of such monomers may be used as the copolymerization component here. Of these, styrene and α-methylstyrene are preferable, from the viewpoint of availability and inexpensiveness.

### Acrylic Polymer

The acrylic polymer preferably has a structural unit derived from an acrylate monomer, as represented by the following general formula (2).

The number-average molecular weight of the acrylic polymer for use in the invention is preferably from 1000 to less than 2000000, more preferably from 5000 to 1000000, even more preferably from 8000 to 500000. In the invention, the content of the acrylic polymer is preferably from 4 to 30% by mass of the cellulose resin, more preferably from 10 to 25% by mass.

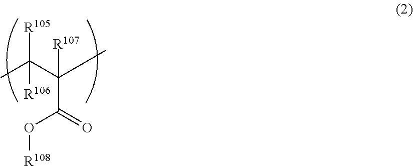

In the formula, R¹⁰⁵ to R¹⁰⁸ each independently represent a hydrogen atom, a halogen atom, or a substituted or unsubstituted hydrocarbon atoms having from 1 to 30 carbon atoms and optionally having a linking group containing an oxygen atom, a sulfur atom, a nitrogen atom or a nitrogen atom, or represents a polar group.

Examples of the acrylate monomer include, for example, methyl acrylate, ethyl acrylate, propyl (i-, n-) acrylate, butyl (n-, i-, s-, tert-) acrylate, pentyl (n-, i-, s-) acrylate, hexyl (n-, i-) acrylate, heptyl (n-, i-) acrylate, octyl (n-, i-) acrylate, nonyl (n-, i-) acrylate, myristyl (n-, i-) acrylate, 2-ethylhexyl) acrylate, (s-caprolactone) acrylate, (2-hydroxyethyl) acrylate, (2-hydroxypropyl) acrylate, (3-hydroxypropyl) acrylate, (4-hydroxybutyl) acrylate, (2-hydroxybutyl) acrylate, (2-methoxyethyl) acrylate, (2-ethoxyethyl) acrylate, phenyl acrylate, phenyl methacrylate, (2- or 4-chlorophenyl) acrylate, (2- or 4-chlorophenyl) methacrylate, (2-, 3- or 4-ethoxycarbonylphenyl) acrylate, (2-, 3- or 4-ethoxycarbonylphenyl) methacrylate, (o- or m- or p-tolyl) acrylate, (o- or m- or p-tolyl) methacrylate, benzyl acrylate, benzyl methacrylate, phenethyl acrylate, phenethyl methacrylate, (2-naphthyl) acrylate, cyclohexyl acrylate, cyclohexyl methacrylate, (4-methylcyclohexyl) acrylate, (4-methylcyclohexyl) methacrylate, (4-ethylcyclohexyl) acrylate, (4-ethylcyclohexyl) methacrylate; and methacrylates corresponding to the above-mentioned acrylates. However, the invention is not limited to these specific examples. Two or more different types of these monomers may be used as the copolymerization component here. Of those, preferred are methyl acrylate, ethyl acrylate, propyl (i-, n-) acrylate, butyl (n-, i-, s-, tert-) acrylate, pentyl (n-, i-, s-) acrylate, hexyl (n-, i-) acrylate, and methacrylates corresponding to these acrylates, from the viewpoint of availability and inexpensiveness.

### Copolymer

Preferably, the copolymer contains at least one structural unit derived from the aromatic vinyl monomer to be represented by the following general formula (1) and the acrylate monomer to be represented by the following general formula (2):

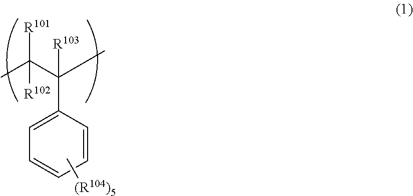

In the formula, R¹⁰¹ to R¹⁰⁴ each independently represent a hydrogen atom, a halogen atom, or a substituted or unsubstituted hydrocarbon group having from 1 to 30 carbon atoms and optionally having a linking group containing an oxygen atom, a sulfur atom, a nitrogen atom or a nitrogen atom, or represents a polar group; R¹⁰⁴'s all may be the same atoms or groups, or each may be a different atom or group, or they may bond to each other to form a carbon ring or a hetero ring (and the carbon ring and the hetero ring may be a monocyclic structure or may form a polycyclic structure as condensed with any other ring).

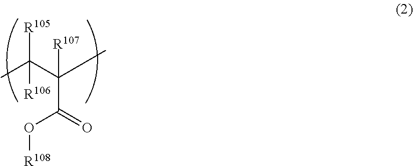

In the formula, R¹⁰⁵ to R¹⁰⁸ each independently represent a hydrogen atom, a halogen atom, or a substituted or unsubstituted hydrocarbon group having from 1 to 30 carbon atoms and optionally having a linking group containing an oxygen atom, a sulfur atom, a nitrogen atom or a nitrogen atom, or represents a polar group.

The other structure than the above that constitutes the copolymer composition is preferably one excellent in copolymerizability with the above-mentioned monomer, and its examples include acid anhydrides such as maleic anhydride, citraconic anhydride, cis-1-cyclohexene-1,2-dicarboxylic acid anhydride, 3-methyl-cis-1-cyclohexene-1,2-dicarboxylic acid anhydride, 4-methyl-cis-1-cyclohexene-1,2-dicarboxylic acid anhydride, etc.; nitrile group-containing radical-copolymerizing monomers such as acrylonitrile, methacrylonitrile, etc.; amide bond-containing radical-polymerizing monomers such as acrylamide, methacrylamide, trifluoromethanesulfonaminoethyl (meth)acrylate, etc.; fatty acid vinyl esters such as vinyl acetate, etc.; chlorine-containing radical-polymerizing monomers such as vinyl chloride, vinylidene chloride, etc.; conjugated dienes such as 1,3-butadiene, isoprene, 1,4-dimethylbutadiene, etc.; to which, however, the invention is not limited. Of those, especially preferred are styrene-acrylic acid copolymer, styrene-maleic anhydride copolymer, and styrene-acrylonitrile copolymer.

The method for producing the cellulose acylate film of the invention is not specifically defined. Preferably, the film is produced according to a melt casting method or a solution casting method to be mentioned below. More preferred is a solution casting method. According to any of such a melt casting method or a solution casting method, the cellulose acylate film of the invention can be produced in any ordinary manner. For example, regarding melt casting film formation, reference is made to is JP-A 2006-348123; and regarding solution casting film formation, reference is made to is JP-A 2006-241433.

### [Solution Casting Film Formation]

A preferred embodiment of producing the cellulose acylate film of the invention according to a solution casting method is described.

In a solution casting method, a solution of cellulose acylate is prepared and the solution is cast onto the surface of a support for film formation thereon. The solvent to be used in preparing the cellulose acylate solution is not specifically defined. For the solvent, preferred are chlorine-containing organic solvents such as dichloromethane, chloroform, 1,2-dichloroethane, tetrachloroethylene, etc.; and non-chlorine organic solvents. The non-chlorine organic solvent is preferably a solvent selected from esters, ketones and ethers having from 3 to 12 carbon atoms. The ester, the ketone and the ether may have a cyclic structure. A compound having at least two functional groups of ester, ketone and ether (that is, —O—, —CO— and —COO—) may also be used as a main solvent, and, for example, the compound may have any other functional group such as an alcoholic hydroxyl group. Regarding the main solvent having at least two functional groups, the number of the carbon atoms constituting the compound may fall within the defined range of the compound having any such functional group.

Examples of the ester having from 3 to 12 carbon atoms include ethyl formate, propyl formate, pentyl formate, methyl acetate, ethyl acetate and pentyl acetate. Examples of the ketone having from 3 to 12 carbon atoms include acetone, methyl ethyl ketone, diethyl ketone, diisobutyl ketone, cyclopentanone, cyclohexanone and methylcyclohexanone. Examples of the ether having from 3 to 12 carbon atoms include diisopropyl ether, dimethoxymethane, dimethoxyethane, 1,4-dioxane, 1,3-dioxolan, tetrahydrofuran, anisole, phenetole. Examples of the organic solvent having at least two functional groups include 2-ethoxyethyl acetate, 2-methoxyethanol and 2-butoxyethanol.

In preparing the cellulose acylate solution, preferably, the cellulose acylate is dissolved in the organic solvent in an amount of from 10 to 35% by mass, more preferably from 13 to 30% by mass, even more preferably from 15 to 28% by mass. The cellulose acylate solution having the concentration falling within the range may be prepared by dissolving the cellulose acylate in the solvent so that the prepared solution could have the predetermined concentration, or may be prepared by first preparing a low-concentration solution (for example, having a concentration of from 9 to 14% by mass) followed by concentrating it in the subsequent concentration step to prepare the intended solution having the concentration falling within the above-mentioned range. Further, a high-concentration cellulose acylate solution may be previously prepared and various additives may be added thereto to make the resulting solution have the intended concentration falling within the above-mentioned range.

In preparing the cellulose acylate solution (dope), the dissolution method is not specifically defined. The solution may be prepared at room temperature, or may be prepared according to a cooling dissolution method or a high-temperature dissolution method, or according to a combination of these methods. In this regard, methods for preparing a cellulose acylate solution are described in, for example, JP-A 5-163301, 61-106628, 58-127737, 9-95544, 10-95854, 10-45950, 2000-53784, 11-322946, 11-322947, 2-276830, 2000-273239, 11-71463, 04-259511, 2000-273184, 11-323017, 11-302388, and these techniques are applicable to the present invention. Regarding the details of these techniques, especially regarding the preparation method using a non-chlorine solvent, reference is made to Hatsumei Kyokai Disclosure Bulletin (No. 2001-1745, published on Mar. 15, 2001 by Hatsumei Kyokai), pp. 22-25. During the step of preparing the cellulose acylate solution, the system may be processed for solution concentration or filtration, and the techniques for the treatment are described in detail in Hatsumei Kyokai Disclosure Bulletin (No. 2001-1745, published on Mar. 15, 2001 by Hatsumei Kyokai), p. 25. In case where the cellulose acylate is dissolved at a high temperature, the dissolution temperature is mostly higher than the boiling point of the organic solvent used, and in such a case, the system is processed under pressure.

### (Concrete Method of Solution Casting Film Formation)

As the method and equipment for producing the cellulose acylate film of the invention, employable are a solution casting film formation method and a solution casting film formation apparatus heretofore used for cellulose acylate film production. The dope (cellulose acylate solution) prepared in a dissolver (tank) is once stored in a reservoir, and defoamed therein to prepare a final dope. The dope is fed to a pressure die, for example, via a pressure metering gear pump capable of feeding a predetermined amount of the dope with accuracy based on the rotation number thereof, and then uniformly cast onto a metal support endlessly running in a casting zone, via a slit of the pressure die, and at the peeling point at which the metal support has conveyed nearly round, the wet dope film (also called web) is peeled from the metal support. The web is clipped on both sides thereof, and with its width kept maintained, the web is conveyed and dried with a tenter, and thereafter further conveyed on rolls in a drying unit in which its drying is finished, and the thus-dried web is wound up to a predetermined length with a winder. The combination of the tenter and the drying unit with rolls may change depending on the intended purpose. In a solution casting film formation method for functional protective films for use in silver halide photosensitive materials or electronic displays, a coating unit for film surface treatment for forming a subbing layer, an antistatic layer, an antihalation layer, a protective layer or the like on the film, is often added to the solution casting film formation unit. The steps of the production process are described in detail in Hatsumei Kyokai Disclosure Bulletin (No. 2001-1745, published on Mar. 15, 2001 by Hatsumei Kyokai), pp. 25-30, as grouped in categories of casting (including cocasting), metal support, drying, peeling, stretching, etc.

### [Treatment of Cellulose Acylate Film]

### (Stretching)

Preferably, the cellulose acylate film of the invention thus produced according to the melt casting method or the solution casting method described as above is stretched.

The film may be stretched on-line in the film formation process, or after once wound up after the completion of film formation, the film may be stretched off-line. Specifically in melt casting film formation, the film formed may be stretched before its cooing is not as yet finished or may be stretched after its cooling has been finished.

Preferably, the film is stretched at (Tg−50)° C. to (Tg+50)° C., more preferably at (Tg−30)° C. to (Tg+30)° C., even more preferably at (Tg−20)° C. to (Tg+20)° C. The preferred draw ratio in stretching is from 0.1% to 300%, more preferably from 10% to 200%, even more preferably from 30% to 100%. The stretching may be attained in one stage or in multiple stages.

The draw ratio in stretching is determined according to the following formula:

Draw Ratio (%)=100×{(length after stretching)−(length before stretching)}/(length before stretching).

The film is stretched in a mode of MD stretching (stretching in the machine direction), or TD stretching (stretching in the direction nearly perpendicular to the machine direction), or a combination thereof. The MD stretching includes (1) roll stretching (also referred to as free-end stretching of stretching the film in the machine direction, using at least two pairs of nip rolls of which the peripheral speed of the rolls on the outlet port side is controlled to be higher), (2) fixed-end stretching (of stretching the film in the machine direction by holding both sides of the film and conveying the film gradually faster in the machine direction), etc. The TD stretching includes tenter stretching (of stretching the film in the transverse direction (perpendicular to the machine direction) by holding both sides of the film with a chuck unit), etc. The MD stretching and the TD stretching may be attained here separately (monoaxial stretching), or may be combined (biaxial stretching). In the case of biaxial stretching, the film may be stretched successively in MD and TD (successive stretching), or may be stretched simultaneously (simultaneous stretching).

The drawing speed in MD stretching and TD stretching is preferably from 10%/min to 10000%/min, more preferably from 20%/min to 1000%/min, even more preferably from 30%/min to 800%/min. In multistage stretching, the drawing speed indicates the mean value of the drawing speed in each stage.

Subsequently to the stretching, it is also desirable to relax the film in the machine direction or in the transverse direction by from 0% to 10%. Also preferably, the film may be thermally fixed at 150° C. to 250° C. for 1 second to 3 minutes after the stretching.

Thus stretched, the film thickness is preferably from 10 to 300 μm, more preferably from 20 μm to 200 μm, even more preferably from 30 μm to 100 μm.

Preferably, the angle θ between the film conveyance direction (machine direction) and the slow axis of Re of the film is nearer to 0°, or +90° or −90°. Specifically, in TD stretching, the angle is preferably nearer to 0°, more preferably 0±3°, even more preferably 0±2°, especially preferably 0±1°. In MD stretching, the angle is preferably 90±3° or −90±3°, more preferably 90±2° or −90±2°, even more preferably 90±1° or −90±1°.

The stretching treatment may be attained during the film formation step; or after the formed film is wound up, the film may be again unwound and may be stretched. In the former case, the film may be stretched while containing the residual solvent therein, and the film may be stretched preferably the residual solvent amount therein is from 2 to 50% by mass, more preferably from 5 to 20% by mass.

The thickness of the dried cellulose acylate film may vary depending on the intended purpose, and is preferably within a range of from 5 to 500 μm, more preferably within a range of from 10 to 300 μm, even more preferably from 20 to 150 μm. For optical use, especially for IPS liquid crystal display devices, the thickness of the film is preferably from 20 to 110 μm. The film thickness may be controlled by controlling the solid concentration in the dope, or the slit aperture of the die nozzle, or the die extrusion pressure or the metal support speed or the like in order that the formed film could have a desired thickness.

The cellulose acylate film of the invention may be formed as a long film. For example, the film may be formed as a wound-up long film having a film width of from 0.5 to 3 m (preferably from 0.6 to 2.5 m, more preferably from 0.8 to 2.2 m) and a film length of from 100 to 10000 m/roll (preferably from 500 to 7000 m/roll, more preferably from 1000 to 6000 m/roll). In winding up the film, preferably, the film is knurled on at least one side thereof; and the knurling width is preferably from 3 mm to 50 mm, more preferably from 5 mm to 30 mm, and the knurling height is preferably from 0.5 to 500 μm, more preferably from 1 to 200 μm. The knurling mode may be a one-way mode or a both-way mode.

The unstretched or stretched cellulose acylate film may be used alone, or may be combined with a polarizer. If desired, a liquid crystal layer, or a refractivity-controlled layer (low-refractivity layer) or a hard coat layer may be formed on the film.

### [Optical Characteristics of Cellulose Acylate Film]

In this description, Re(λ) and Rth(λ) each mean the in-plane retardation (nm) and the thickness-direction retardation (nm) of the film at a wavelength λ. Re(λ) may be measured with KOBRA21ADH or WR (by Oji Scientific Instruments), by applying to the film a light having a wavelength of λ nm in the normal direction of the film.

In case where the film to be analyzed is one capable of being expressed by a monoaxial or biaxial index ellipsoid, Rth(λ) may be calculated according to the method mentioned below.

With the in-plane slow axis (determined by KOBRA 21ADH or WR) taken as the tilt axis (rotation axis) of the film (in case where the film has no slow axis, the rotation axis of the film may be in any in-plane direction of the film), Re(λ) of the film is measured at 6 points in all thereof, from the normal direction of the film up to 50 degrees on one side relative to the normal direction thereof at intervals of 10 degrees, by applying a light having a wavelength of λ nm from the tilted direction of the film. Based on the thus-determined retardation data, the assumptive mean refractive index and the inputted film thickness, Rth(λ) of the film is computed with KOBRA 21ADH or WR.

In the above, when the film has a direction in which the retardation thereof is zero at a certain tilt angle relative to the in-plane slow axis thereof in the normal direction taken as a rotation axis, the sign of the retardation value of the film at the tilt angle larger than that tilt angle is changed to negative prior to computation with KOBRA 21ADH or WR.

Apart from this, Re(λ) may also be measured as follows: With the slow axis taken as the tilt axis (rotation axis) of the film (in case where the film has no slow axis, the rotation axis of the film may be in any in-plane direction of the film), the retardation is measured in any desired two directions, and based on the thus-determined retardation data, the assumptive mean refractive index and the inputted film thickness, Rth is computed according to the following formulae (11) and (12).

$$\begin{matrix}Re ( θ ) = [ nx - \frac{ny \times nz}{\sqrt{\begin{matrix}{\{ ny sin ( {sin}^{- 1} ( \frac{sin ( - θ )}{nx} ) ) \}}^{2} + \\ {\{ nz cos ( {sin}^{- 1} ( \frac{sin ( - θ )}{nx} ) ) \}}^{2}\end{matrix}}} ] \times \frac{d}{cos \{ {sin}^{- 1} ( \frac{sin ( - θ )}{nx} ) \}} & ( 11 ) \\ Rth = \{ ( nx + ny ) / 2 - nz \} \times d & ( 12 )\end{matrix}$$

In the above formulae, Re(θ) means the retardation of the film in the direction tilted by an angle θ from the normal direction to the film.

nx means the in-plane refractive index of the film in the slow axis direction; ny means the in-plane refractive index of the film in the direction perpendicular to nx; nz means the refractive index in the direction perpendicular to nx and ny; and d means the film thickness.

In case where the film to be analyzed is not expressed as a monoaxial or biaxial index ellipsoid, or that is, when the film does not have an optical axis, Rth(λ) thereof may be computed as follows:

With the in-plane slow axis (determined by KOBRA 21ADH or WR) taken as the tilt axis (rotation axis) of the film, Re(λ) of the film is measured at 11 points in all thereof, in a range of from −50 degrees to +50 degrees relative to the film normal direction thereof at intervals of 10 degrees, by applying a light having a wavelength of λ nm from the tilted direction of the film. Based on the thus-determined retardation data, the assumptive mean refractive index and the inputted film thickness, Rth(λ) of the film is computed with KOBRA 21ADH or WR.

In this, for the assumptive mean refractive index, referred to are the data in Polymer Handbook (John Wiley & Sons, Inc.) or the data in the catalogues of various optical films. Films of which the mean refractive index is unknown may be analyzed with an Abbe's refractiometer to measure the mean refractive index thereof. Data of the mean refractive index of some typical optical films are mentioned below. Cellulose acylate (1.48), cycloolefin polymer (1.52), polycarbonate (1.59), polymethyl methacrylate (1.49), polystyrene (1.59).

With the assumptive mean refractive index and the film thickness inputted thereinto, KOBRA 21ADH can compute nx, ny and nz.

Re and Rth of the cellulose acylate film of the invention may be controlled by controlling the degree of substitution with the substituent A, DSA, the total degree of substitution, DS, and the draw ratio in the optional step of stretching. The cellulose acylate film of the invention contains a cellulose acylate in which the degree of substitution with the substituent A, DSA and the total degree of substitution DS satisfy the above-mentioned formulae (I) and (II), respectively; and therefore, the absolute value of Re of the stretched cellulose acylate film can be large and the absolute value of Rth thereof can be small. Concretely, the cellulose acylate film of the invention can be a film of which Re(550) is from 180 to 300 nm and Rth(550) is from −30 to 30 nm, and can be, for example, a film of which Re(550) is from 250 to 350 nm or so, Rth(550) is from 0 to 30 nm or so, and Nz is around 0.5 or so (concretely, from 0.25 to 0.65). However, the optical characteristics of the cellulose acylate film of the invention are not limited to those ranges.

The in-plane slow axis of the cellulose acylate film of the invention may be in any direction of MD or TD.

Preferably, the fluctuation in Re(590) of the film in the width direction thereof is ±5 nm, more preferably ±3 nm. Also preferably, the fluctuation in Rth(590) of the film in the width direction thereof is ±10 nm, more preferably ±5 nm. Preferably, the fluctuation in Re and Rth of the film in the length direction thereof is also within the range of the fluctuation thereof in the width direction of the film.

One example of the stretched cellulose acylate film of the invention is a film of which the in-plane slow axis is in the direction perpendicular to the stretching direction. The in-plane slow axis direction of the stretched film is influenced by the DSA value of the cellulose acylate used in forming the cellulose acylate film; and concretely, when DSA of the cellulose acylate is high, then the in-plane slow axis of the stretched cellulose acylate film formed by the use of the cellulose acylate tends to be in the direction perpendicular to the stretching direction. Accordingly, the in-plane slow axis of the stretched cellulose acylate film of the invention could be in the direction perpendicular to the stretching direction. However, the invention is not limited to this embodiment. The in-plane slow axis direction of the film can be detected with KOBRA 21ADH.

### [Haze of Cellulose Acylate Film]

The haze of the cellulose acylate film, as measured with a haze meter (Nippon Denshoku Industry's Model 1001 DP), is preferably from 0.01 to 0.8, more preferably from 0.02 to 0.7, even more preferably from 0.05 to 0.60. When the haze of the film is controlled to fall within the range and when the film is incorporated in a liquid crystal display device as the optical compensatory film therein, then a high-contrast image can be obtained.

### [Photoelastic Coefficient of Cellulose Acylate Film]

Preferably, the cellulose acylate film of the invention is used as a polarizer protective film or a retardation plate. When the film is used as a polarizer protective film or a retardation plate, the birefringence (Re, Rth) of the film may change owing to the stress given thereto through elongation or shrinkage by moisture absorption of the film. The birefringence change accompanied by such stress can be measured as a photoelastic coefficient, and the range thereof preferably falls from 5×10−7 (cm²/kgf) to 30×10−7 (cm²/kgf), more preferably from 6×10−7 (cm²/kgf) to 25×10−7 (cm²/kgf), even more preferably from 7×10−7 (cm²/kgf) to 20×10−7 (cm²/kgf).

### [Glass Transition Temperature of Cellulose Acylate Film]

The glass transition temperature of the cellulose acylate film was measured according to a DMA method. Concretely, a test piece of the film was heated from room temperature at a rate of 5° C./min, and the dynamic viscoelasticity and tan δ of the test piece were measured with a viscoelasticity meter. From the peak temperature to give tan δ, the glass transition temperature of the film was calculated.

The glass transition temperature of the cellulose acylate film of the invention is preferably from 80° C. to 300° C., more preferably from 100° C. to 250° C. The glass transition temperature may be lowered by adding to the film, low-molecular compounds such as plasticizer, solvent, etc.

### [Surface Treatment of Cellulose Acylate Film]

In addition the surface modification thereof by additionally forming a surface layer according to the above-mentioned co-casting method or the like, the unstretched or stretched cellulose acylate film may be processed for any other surface treatment either singly or optionally as combined with the surface modification treatment, thereby enhancing the adhesiveness of the cellulose acylate film to various functional layers (for example, undercoat layer, back layer) For example, the film may be surface-treated through glow discharge treatment, UV irradiation treatment, corona treatment, flame treatment, or acid or alkali treatment.

### [Retardation Film]

The cellulose acylate film of the invention may be used as a retardation film.

Preferably, the cellulose acylate film of the invention is combined with the functional layer described in detail in Hatsumei Kyokai Disclosure Bulletin (No. 2001-1745, published on Mar. 15, 2001 by Hatsumei Kyokai), pp. 32-45. Especially preferably, a polarizing film is given to the film (for forming a polarizer), or an optical compensatory layer of a liquid crystal composition is given thereto (for forming an optical compensatory film), or an antireflection layer is given thereto (for forming an antireflection film).

### [Optical Compensatory Film]

The cellulose acylate film of the invention can be used for optical compensation in liquid crystal display devices. In case where the cellulose acylate film of the invention satisfies optical characteristics necessary for optical compensation, the film can be directly used as an optical compensatory film. For making the film satisfy optical characteristics necessary for optical compensation, the film may be laminated with any other one or more layers of, for example, an optically anisotropic layer formed by curing a liquid crystal composition, or a layer of any other birefringent polymer film, and the resulting laminate film may be used as an optical compensatory film.

### [Antireflection Film]

The invention also relates to an antireflection film comprising the cellulose acylate film of the invention and an antireflection layer formed thereon. The antireflection film can be produced according to an ordinary production method, and for example, can be formed with reference to JP-A 2006-241433.

### 2. Polarizer

The invention also relates to a polarizer comprising the cellulose acylate film of the invention and a polarizing film. One example of the polarizer of the invention comprises a polarizing film and two protective films to sandwich the polarizing film, in which at least one of the two protective films is the cellulose acylate film of the invention. The cellulose acylate film may be stuck to polarizer, serving as a part of an optical compensatory film having an optically anisotropic layer, or as a part of an antireflection film having an antireflection layer. In a case where the polarizer has any other layer, it is desirable that the surface of the cellulose acylate film of the invention is stuck to the surface of the polarizer. For example, the polarizer may be produced with reference to JP-A 2006-241433.

The cellulose acylate which the cellulose acylate film of the invention contains as the main ingredient thereof has a low degree of acyl substitution, and is therefore characterized in that the OH content in the film is large and the film is suitably flexible. Consequently, the adhesiveness of the film to a polarizing film that comprises a hydrophilic polyvinyl alcohol (PVA) as the main ingredient thereof is high, therefore causing no problem of peeling or delamination. Concretely, in a cross-cut test where a laminate sample of the cellulose acylate film of the invention and a polyvinyl alcohol film is prepared and tested, the PVA residual ratio is preferably at least 85%, more preferably at least 90%, even more preferably at least 95%, most preferably 100%, or that is, PVA does not peel at all in the test.

The cross-cut test is carried out according to JIS K5600-5-6, Section 6. In preparing the above sample, a polyvinyl alcohol-type adhesive such as polyvinyl alcohol, polyvinyl butyral or the like, and a vinyl latex of butyl acrylate or the like may be used.

### 3. Image Display Device

The invention also relates to an image display device containing at least one cellulose acylate film of the invention.

The cellulose acylate film of the invention is used as a retardation film or an optical compensatory film, or is used in the display device as a part of the polarizer, an optical compensatory film or an antireflection film.

<Liquid crystal Display Device>

The cellulose acylate film of the invention can be incorporated in a liquid crystal display device, as a retardation film, or as a polarizer, an optical compensatory film or an antireflection film comprising the cellulose acylate film. The liquid crystal display device includes TN-mode, IPS-mode, FFS-mode, FLC-mode, AFLC-mode, OCB-mode, STN-mode, ECB-mode, VA-mode and HAN-mode liquid crystal devices. In the invention, preferred are horizontal alignment mode devices such as IPS-mode devices, etc. The cellulose acylate film of the invention can be used in any liquid crystal display devices of transmission-type, reflection-type or semitransmission-type devices.

In case where the cellulose acylate film of the invention is used in a horizontal alignment mode liquid crystal display device such as an IPS-mode device, preferably, a sheet of the film is arranged between the liquid crystal cell and the panel-side polarizer the backlight-side polarizer. The film may also be functioned as a protective film for the panel-side polarizer or the backlight-side polarizer, and may be incorporated in a liquid crystal display device as a part of the polarizer therein existing between the liquid crystal cell and the polarizing film. When a sheet of the cellulose acylate film of the invention is arranged in the above-mentioned position in an IPS-mode liquid crystal display device, then the display characteristics of the device can be remarkably enhanced, and in particular, the color shift in oblique direction at the time of black level of display can be significantly reduced. In the embodiment where the cellulose acylate film of the invention is used for optical compensation in the IPS-mode liquid crystal display device, Rth of the film is preferably from −30 nm to 30 nm, and Re thereof is preferably from 250 nm to 350 nm. In the embodiment, the Nz value of the film is preferably 0.5 or so, and concretely, the Nz value preferably falls between 0.25 and 0.65. In the embodiment, preferably, the cellulose acylate film of the invention is so arranged that the in-plane slow axis thereof could be parallel to or perpendicular to the absorption axis of the panel-side polarizing film (or the backlight-side polarizing film).

In the above embodiment, preferably, no other retardation layer than the cellulose acylate film exists between the panel-side polarizing film or the backlight-side polarizing film and the liquid crystal cell, from the viewpoint of thinning the display device. Accordingly, for example, in case where the panel-side polarizer or the backlight-side polarizer has any other polarizer protective film than the cellulose acylate film and when the protective film is arranged between the liquid crystal cell and the panel-side polarizing film or the backlight-side polarizing film, then it is desirable that an isotropic polymer film of which both Re and Rth are nearly 0 (zero) is used for the protective film. The polymer film of the type is preferably the cellulose acylate film described in JP-A 2006-030937.

### EXAMPLES

The invention is described more concretely with reference to the following Examples, in which the material used, its amount and ratio, the details of the treatment and the treatment process may be suitably modified or changed not overstepping the spirit and the scope of the invention. Accordingly, the invention should not be limitatively interpreted by the Examples mentioned below.

### Examples

### 1. Synthesis of Cellulose Acylate

Cellulose acylates A-1 to 21 and B-1 to 3, each having a different degree of substitution, DSA and DS as shown in Table 3 mentioned below, were synthesized according to the method of saponification of cellulose acylate described in JP-A 2008-163193, [0121] and according to the method of aromatic acylation of cellulose acylate also described in the same patent reference, [0124]. The substituent A that the thus-synthesized cellulose acylates have is a benzoyl group in every case.

### 2. Production of Cellulose Acylate Film

### (1) Preparation of Cellulose Acylate Solution

Solutions of the cellulose acylate synthesized in the above were prepared according to the preparation method 1 or mentioned below.

### <Preparation Method 1 for Cellulose Acylate Solution>

The following starting materials were put into a mixing tank, and stirred with heating and dissolved to prepare a cellulose acylate solution.

| | |
|---|---|
| Cellulose acylate | 100 parts by mass |
| Dichloromethane | 462 parts by mass |

### <Preparation Method 2 for Cellulose Acylate Solution>

The following starting materials were put into a mixing tank, and stirred with heating and dissolved to prepare a cellulose acylate solution.

| | | |
|---|---|---|
| Cellulose acylate | 91 | parts by mass |
| Additive (shown in Table 3) | 9 | parts by mass |
| Dichloromethane | 462 | parts by mass |

### (2) Production of Cellulose Acylate Film

Using a band caster, the cellulose acylate solution prepared in the above was cast. The film having a residual solvent amount of 15% by mass was stretched at a temperature of (glass transition temperature thereof −5° C.) and at a draw ratio of 45% in a fixed-end monoaxial stretching mode, thereby producing a cellulose acylate film shown in Table 3. Unless otherwise specifically indicated, the thickness of the formed film is 60 μm in every case.

### (3) Evaluation of Cellulose Acylate Film

### Optical Characteristics:

Re and Rth of the obtained film were measured according to the above-mentioned method, and Nz thereof was calculated. The results are shown in Table 3 below.

### Brittleness:

The obtained film was cut into a piece of 35 mm×140 mm, then conditioned at a temperature of 25° C. and a relative humidity of 60% for 2 hours, and rounded to be a cylindrical form having a diameter of 40 mm, whereupon the film was checked for cracking or chapping to thereby evaluate the flexibility thereof. The results are shown in the column of “brittleness” in Table 3 below. The mark in the column of “brittleness” means the following:

A: No chapping.

B: Chapping detected microscopically.

C: The film cracked.

### Adhesiveness to PVA:

The obtained film was stuck to a PVA film with a polyvinyl alcohol adhesive to prepare a laminate sample. The sample was tested in a cross-cut test according to JIS K5600-5-6, Section 6. The results are shown in Table 3 below in the column of “adhesiveness to PVA”. The numerical value in the column of “adhesiveness to PVA” means the following:

5: No peeling.

4: Peeling was at most 15%, or that is, the residual ratio was at least 85%.

3: Peeling was from more than 15% to 30%, or that is, the residual ratio was from 70% to less than 85%.

2: Peeling was from more than 30% to 50%, or that is, the residual ratio was from 50% to less than 70%.

1: Peeling was more than 50%, or that is, the residual ratio was less than 50%.

### 3. Production and Evaluation of Polarizer

### (1) Production or Polarizer

The cellulose acylate film was saponified. A commercially-available triacetyl cellulose film “Fujitac T40UZ” was saponified in the same manner.

A polarizing film, one of the above-saponified films (referred to as film A), and the above-saponified commercial product triacetyl cellulose film as the other protective film (“Tac” in Table 4, referred to as film B) were used. The polarizing film was sandwiched between the two films, and stuck together using an aqueous solution of 3% PVA (Kuraray's PVA-117H) as an adhesive in such a manner that the absorption axis direction of the polarizing film could be parallel to the slow-axis direction of the protective films, thereby producing polarizers PSA1, 4, 15, 20, 21 and PSB2 shown in Table 4 below.

SA-1′ used in the film A for PSA1 was modified from SA-1 by changing the thickness thereof from 60 μm to 30 μm.

### (2) Evaluation of Polarizer

The thus-constructed polarizer was incorporated into an IPS-mode liquid crystal display device (37-inch high-definition liquid crystal TV monitor, Toshiba's 37Z2000) in place of the viewers' side polarizer originally set therein, in such a manner that the film A could be on the liquid crystal cell side, and tested for the brightness at the time of black level of display at the site where the light leakage in the polar angle 60° direction was the largest, and evaluated according to the following criteria.

A: At most 1.5 cd/m².

B: From more than 1.5 cd/m² to 5.0 cd/m².

C: More than 5.0 cd/m².

The results are shown in Table 4 below.

TABLE 3
Results of Evaluation of Cellulose Acylate Film

| | Cellulose | | | | | Solution | | | | | | | |
|---|---|---|---|---|---|---|---|---|---|---|---|---|---|
| Film | Acylate | | | | | Casting | Rth | Re | | Adhesiveness | | In-Plane | |
| No. | No. | Additive | DSA | DSB | DS | Method | (nm) | (nm) | Nz | to PVA | Brittleness | Slow Axis | Remarks |
| SA-1 | A-1 | no | 1.9 | 0 | 1.9 | 1 | −48 | 396 | 0.62 | 4 | B | MD | the invention |
| SA-2 | A-2 | no | 0.9 | 1.0 | 1.9 | 1 | 14 | 182 | 0.58 | 4 | B | MD | the invention |
| SA-3 | A-3 | no | 0.9 | 0.0 | 0.9 | 1 | 21 | 187 | 0.61 | 5 | B | MD | the invention |
| SA-4 | A-4 | no | 1.2 | 0.6 | 1.8 | 1 | −2 | 292 | 0.51 | 5 | A | MD | the invention |
| SA-5 | A-5 | no | 1.2 | 0.7 | 1.9 | 1 | −8 | 283 | 0.53 | 4 | B | MD | the invention |
| SA-6 | A-6 | no | 1.2 | 0.5 | 1.7 | 1 | 6 | 281 | 0.52 | 5 | B | MD | the invention |
| SA-7 | A-7 | no | 1.3 | 0.5 | 1.8 | 1 | 13 | 320 | 0.54 | 4 | B | MD | the invention |
| SA-3 | A-8 | no | 1.1 | 0.7 | 1.8 | 1 | 7 | 250 | 0.53 | 4 | B | MD | the invention |
| SA-9 | A-9 | no | 1.1 | 0.8 | 1.9 | 1 | 5 | 253 | 0.52 | 4 | B | MD | the invention |
| SA-10 | A-10 | no | 1.3 | 0.6 | 1.9 | 1 | 10 | 321 | 0.53 | 4 | B | MD | the invention |
| SA-11 | A-11 | no | 1.3 | 0.4 | 1.7 | 1 | 14 | 318 | 0.54 | 5 | A | MD | the invention |
| SA-12 | A-12 | no | 1.1 | 0.6 | 1.7 | 1 | 8 | 255 | 0.53 | 5 | A | MD | the invention |
| SA-13 | A-13 | no | 1.5 | 0.4 | 1.9 | 1 | −23 | 345 | 0.57 | 4 | B | MD | the invention |
| SA-14 | A-14 | no | 1.5 | 0.0 | 1.5 | 1 | −15 | 333 | 0.55 | 5 | A | MD | the invention |
| SA-15 | A-15 | no | 0.9 | 0.6 | 1.5 | 1 | 15 | 181 | 0.58 | 5 | A | MD | the invention |
| SA-16 | A-16 | no | 1.5 | 0.3 | 1.8 | 1 | −19 | 327 | 0.56 | 4 | B | MD | the invention |
| SA-17 | A-17 | no | 1.2 | 0.3 | 1.5 | 1 | 23 | 278 | 0.58 | 5 | A | MD | the invention |
| SA-18 | A-18 | no | 0.9 | 0.9 | 1.8 | 1 | 16 | 183 | 0.59 | 3 | B | MD | the invention |
| SA-20 | A-20 | methacrylate | 1.2 | 0.6 | 1.8 | 2 | −3 | 327 | 0.51 | 4 | B | MD | the invention |
| SA-21 | A-21 | polyester | 1.2 | 0.6 | 1.8 | 2 | −5 | 330 | 0.52 | 5 | A | MD | the invention |
| | | polymer | | | | | | | | | | | |
| SB-1 | B-1 | no | 2.0 | 0.2 | 2.2 | 1 | −44 | 400 | 0.61 | 2 | C | MD | comparative |
| | | | | | | | | | | | | | example |
| SB-2 | B-2 | no | 0.8 | 0.1 | 0.9 | 1 | 72 | 148 | 0.99 | 5 | A | MD | comparative |
| | | | | | | | | | | | | | example |

Additive: “methacrylate” is “Dianal BR-83” (polymethyl methacrylate, having a molecular weight of about 400,000, produced by Mitsubishi Rayon); and “polyester polymer” is P-45 in Table 2.

TABLE 4
Results of Evaluation of Polarizer

| Polarizer | | | | | |
|---|---|---|---|---|---|
| No. | Film A | Film B | Additive | Visibility | Remarks |
| PSA-4 | SA-4 | Tac | no | A | the invention |
| PSA-20 | SA-20 | Tac | methacrylate | A | the invention |
| PSA-21 | SA-21 | Tac | polyester | A | the invention |
| | | | polymer | | |
| PSA-15 | SA-15 | Tac | no | A | the invention |
| PSA-1 | SA-1′ | Tac | no | B | the invention |
| PSB-2 | SB-4 | Tac | no | C | comparative |
| | | | | | example |

While the present invention has been described in detail and with reference to specific embodiments thereof, it will be apparent to one skilled in the art that various changes and modifications can be made therein without departing from the spirit and scope thereof.

The present disclosure relates to the subject matter contained in International Application No. PCT/JP2012/072516, filed Aug. 29, 2012; and Japanese Patent Application No. 2011-188351 filed on Aug. 31, 2011, the contents of which are expressly incorporated herein by reference in their entirety. All the publications referred to in the present specification are also expressly incorporated herein by reference in their entirety.

The foregoing description of preferred embodiments of the invention has been presented for purposes of illustration and description, and is not intended to be exhaustive or to limit the invention to the precise form disclosed. The description was selected to best explain the principles of the invention and their practical application to enable others skilled in the art to best utilize the invention in various embodiments and various modifications as are suited to the particular use contemplated. It is intended that the scope of the invention not be limited by the specification, but be defined claims.

1. A cellulose acylate film composed of a composition that comprises at least one cellulose acylate, wherein the cellulose acylate has an aromatic group-containing acyl group, Substituent A, and satisfies the following formulae (I) and (II):
0.9≦DSA<2.0 (I)
0.9≦DS<2.0 (II)
wherein DSA is a degree of substitution with the Substituent A, and DS is a total degree of substitution.

2. The cellulose acylate film according to claim 1, satisfying 180 nm≦Re(550)≦300 nm, and 0 nm≦|Rth(550)|≦30 nm.

3. The cellulose acylate film according to claim 1, having a thickness of from 40 to 70 μm.

4. The cellulose acylate film according to claim 1, wherein the cellulose acylate further has an aliphatic acyl group, Substituent B.

5. The cellulose acylate film according to claim 1, wherein the Substituent B is an acetyl group.

6. The cellulose acylate film according to claim 1, wherein the degree of substitution with the Substituent B, DSB, satisfies the following formula (III):
0≦DSB<1.1 (III)

7. The cellulose acylate film according to claim 1, wherein the Substituent A is selected from a benzoyl group, a phenylbenzoyl group, a 4-heptylbenzoyl group, a 2,4,5-trimethoxybenzoyl group and a 3,4,5-trimethoxybenzoyl group.

8. The cellulose acylate film according to claim 1, comprising a plasticizer.

9. The cellulose acylate film according to claim 1, of which the PVA residual ratio in the cross-cut test of the laminate, as laminated with a polyvinyl alcohol film, is at least 85%.

10. A polarizer having a polarizing film and a cellulose acylate film, wherein the cellulose acylate film is composed of a composition that comprises at least one cellulose acylate, wherein the cellulose acylate has an aromatic group-containing acyl group, Substituent A, and satisfies the following formulae (I) and (II):
0.9≦DSA<2.0 (I)
0.9≦DS<2.0 (II)
wherein DSA is a degree of substitution with the Substituent A, and DS is a total degree of substitution.

11. An image display device having a polarizer having a polarizing film and a cellulose acylate film, wherein the cellulose acylate film is composed of a composition that comprises at least one cellulose acylate, wherein the cellulose acylate has an aromatic group-containing acyl group, Substituent A, and satisfies the following formulae (I) and (II):
0.9≦DSA<2.0 (I)
0.9≦DS<2.0 (II)
wherein DSA is a degree of substitution with the Substituent A, and DS is a total degree of substitution.
